(19) United States
(12) Patent Application Publication
(10) Pub. No.: US 2008/0216292 A1
(43) Pub. Date: Sep. 11, 2008

(54) Fasteners, Especially Temporary Fasteners

(75) Inventors: Dickory Rudduck, Chicago, IL (US); Lee Blattmann, Wilmette, IL (US)

Correspondence Address: TELEZYGOLOGY, INC., 520 W. ERIE STREET, SUITE 210, CHICAGO, IL, 60654, US

(73) Assignee: Telezygology, Inc., Chicago, IL (US)

(21) Appl. No.: 10/597,656

(22) PCT Filed: Feb. 4, 2005
(86) PCT No.: PCT/AU05/00137

§ 371 Date: Aug. 2, 2006

(30) Foreign Application Priority Data
Feb. 4, 2004 (AU) 2004900529
May 11, 2004 (AU) 2004902475

(51) Int. Cl. B65D 63/00; F16B 13/06; A44B 21/00

(52) U.S. Cl. 24/16 R; 24/1; 24/454

(57) ABSTRACT

Fastener (80) joins together work pieces (14, 18) and has longitudinal body (82) with first work engaging member (86) mounted on it. Second work engaging member (90) is associated with longitudinal body (82) and may be integral with il, or joined to it or mounted on it. Ratchet teeth (22) and ratchet lock (92) allow for adjustment of the position of first work engaging member (86) on longitudinal body (82). Second work engaging member (90) includes leaf members (94) capable of assuming a first position of narrow cross-sectional area (as shown in the drawing), and a second position of a wide cross-sectional area under the influence of expanded part (100). Fastener (80) may be removable from work pieces (14, 18).

### TECHNICAL FIELD

This invention relates to fasteners. The type of fastener with which the invention is concerned is particularly useful as a temporary fastener but the invention is not limited to that application.

### BACKGROUND ART

Temporary fasteners are used in various fields, such as in the aerospace industry and particularly in the assembly, maintenance and repair of aircraft and in the custom auto industry. For ease of illustration, the description below will deal generally with the aerospace industry. However, it is to be understood that the invention is not limited to this area.

To a large degree, aircraft manufacture, maintenance and repair involves insertion of fasteners by hand. For example, in manufacture of aircraft the assembly of the panels to the frame is exceptionally labour intensive. Each rivet is normally hand-fastened. Much the same procedure is followed for maintenance and repair.

As part of the riveting procedure, it is necessary to hold a panel to the frame, or to hold different layers together, by using temporary fasteners. It is common practice to use a temporary fastener in every sixth or eighth rivet hole for this purpose. The use of power tools is limited, particularly in the case of maintenance and repair where there is a high danger of explosion through sparking. Consequently, the various types of temporary fasteners which have been designed for use in the aircraft industry require insertion and/or extraction by hand or by use of hand tools.

There are several types of temporary fasteners which have been designed for use in the aerospace industry. Perhaps the most popular is known as the Cleco fastener. These are spring-loaded and are installed by the use of special pliers, which compress the spring to extend an internal pin downwardly. In this configuration, the pin may be inserted in the rivet hole. Once the compressed spring is released, tension on the pin will draw the skin or panel to the frame or the layers of material together.

Another type of prior art fastener is the wedge fastener. This type of fastener has two or more flexible arms which can be inserted into the rivet hole. The arms end in expanded shoulders and the layers of material to be clamped are compressed between the shoulders and a spacer forced towards the panels to be secured.

There are many drawbacks experienced with prior art fasteners. They can be expensive and awkward to use. They can cause burring to the rivet hole, requiring deburring and swarf removal. They can be limited as to depth and pressure requirements, thus necessitating a range of different fasteners, depending on purpose. There can be problems in riveting composite materials, or with materials having curved surfaces. Installation and removal may require a certain amount of physical strength on the part of the operator. Removal of the fastener is often more difficult than installation, particularly if the layers of material are bonded as well as riveted. Prior art fasteners may jam in the rivet holes, requiring physical force to dislodge them. Jamming may be exacerbated when sealant or adhesive is used between the layers of material to be riveted. Fasteners need to be cleaned periodically to remove adhesive.

There are various drawbacks experienced with the use of special tools required to install temporary fasteners, such as Cleco. For example, the special pliers may be somewhat clumsy to use and can slow down the installation of the temporary fasteners, because the fastener must be fed into the tool each time before installation. Since hundreds of temporary fasteners need to be installed during a shift, the fingers of the user may experience pain or suffer damage. The special pliers may be difficult to operate if the user has small hands. A significant amount of physical strength may be required to compress the spring of the Cleco fastener using the special pliers. Attempts to use power versions of the special pliers have not been satisfactory, because of access problems and the variety of fasteners which needs to be handled. These requirements for physical strength may limit the type of worker who can be employed in the aerospace industry.

It is an object of this invention, at least in some embodiments, to provide a temporary fastener which does not necessarily require the fastener to be initially mounted in a special tool for installation. It is a further aim of the invention to provide a temporary fastener which is relatively simple to use and which obviates or alleviates some of the other disadvantages found with prior art fasteners, and, for example, which can accommodate different depth and pressure requirements. It is a further object of the present invention, at least in some embodiments, to provide a fastener which can be used to fasten the different types of materials which are becoming increasingly common in the aerospace industry, such as composite materials including carbon fibre and/or fibreglass as well as steel and aluminium. It is a further object of this invention, at least in some embodiments, to provide a temporary fastener which can be used with curved panels, such as those necessary for aircraft construction.

Where a releasable fastener is required for temporarily fastening work surfaces in a “blind” situation, such as the attachment of surface material to the wing of an aircraft, it may be a requirement that the fastener be removable in a single assembly and that no part of the fastener is sheared off so as to be left behind. Embodiments of the present invention may be useful in a “blind” situation.

### DISCLOSURE OF THE INVENTION

Accordingly, in a first aspect, the present invention provides a fastener including:
a longitudinal body;
a first work engaging member mounted on the longitudinal body;
a second work engaging member associated with the longitudinal body; and
means on the longitudinal body for adjusting position of the first work engaging member on the longitudinal body,
   the second work engaging member including means capable of assuming a first position of narrow cross-sectional area and a second position of wide cross-sectional area.

The fastener of the invention is preferably intended for use as a temporary fastener. However, the fastener of the invention may also be employed as a permanent fastener. Such a fastener can be used as a temporary fastener or tack, especially in the aerospace industry, the fastener being removed by drilling out where it is no longer required.

The fastener is preferably made fully or partly of material such as glass-filled nylon or similar material (but other materials may also be suitable). One or more different materials may be used in combination. For recycling purposes, it is preferred to use a single material, however.

The fastener of the invention may take any suitable shape. Non limiting examples are cross-sectional shapes which are circular, square or hexagonal. Similarly, elements of the fastener may have cross-sectional shapes which are circular, square or hexagonal, as examples.

The first work engaging member may take the form of a bearing or pressure foot, mounted on the longitudinal body and adapted to be urged towards work surfaces which are to be trapped between the first work engaging member and the second work engaging member, so as to create pressure on the work surfaces and compress them together. The first work engaging member may include a shear gallery to assist in shearing off the second work engaging member in those embodiments where this is desirable.

The first work engaging member, preferably in the form of the pressure foot, may present a flat profile or a profile of another shape to the work surface it is to contact. The foot may assume any desirable shape. In particular, the foot may be shaped so as to fit into a depression formed in the work surface so that, ultimately, the rivets or other permanent fasteners will be countersunk into the surface.

The second work engaging member is associated with the longitudinal body. Preferably, the second work engaging is mounted on or attached to or integral with the longitudinal body. Where the second work engaging member is separate from the longitudinal body, in one embodiment it is integral with, or joined to, the first work engaging member.

It is preferred that a guide or locater probe is included at one end of the longitudinal body, to assist in guiding the fastener into an aperture such as a rivet hole. The other end of the longitudinal body may include a guide for a tool for insertion of the fastener.

The second work engaging member includes means capable of assuming two positions. In the first position, where the means is of narrow cross-sectional area, the second work engaging member can be inserted through an aperture such as a rivet hole. In the second position, the cross-sectional area of the means should be wide enough to prevent the means being withdrawn from the aperture. In this way, it is possible to trap the work surfaces between the first and second work engaging members and to fasten them together.

Various embodiments of the means capable of assuming the first and second positions may be apparent to one skilled in the art. In a preferred embodiment, the means may be expandable and collapsible or can otherwise change shape so that the fastener can be withdrawn from engagement with the work surfaces. Embodiments of this are described below in connection with the drawings, and include wings and leaves.

The means on the longitudinal body for adjusting position of the first work engaging member on the longitudinal body may take any appropriate form. In one form, the means is a type of ratchet teeth/pawl combination. In this embodiment, the longitudinal body preferably carries ratchet teeth for over half its length. The pawl element is preferably mounted on the longitudinal body in engagement with the ratchet teeth. The pawl element may be adapted to engage the ratchet teeth so that the pawl element can move in one direction only, namely towards the first and second work engaging members. However, an alternate arrangement is one where the pawl element can be released from engagement with the ratchet teeth, so that the movement of the pawl element towards the first and second work engaging members can be reversed and the pawl element may be moved in the opposite direction.

The pawl element may be formed integrally with the first work engaging member. The pawl element is preferably mounted on the longitudinal body in engagement with the ratchet teeth. It is preferred that the pawl element is adapted to engage the ratchet teeth so that the pawl element can move in one direction only, namely towards the first and second work engaging members.

The position adjusting means may take other forms. One non-limiting example is the type of arrangement used for caulking guns, whether manually operated or operated by air or water, for instance. Another example is a screw-based arrangement, which can advance the first working engaging member in small increments. Still another example is an arrangement which provides unidirectional movement of the first work engaging member towards the work to be fastened, reverse movement being prevented or impeded by, for instance, means similar to scales used in a larger version on cross-country skis. Such an arrangement may be adapted to a molecular level via nanotechnology. Other examples will be apparent to one skilled in the art. Some of those other arrangements may permit infinite adjustability, rather than discrete adjustability which is found with the use of the ratchet teeth and pawl combination.

In one embodiment, the first work engaging member, the second work engaging member and the pawl element are made in one piece or in a fixed spatial relationship so that, essentially, the fastener comprises two parts, the first part being the longitudinal body having the ratchet teeth and, optionally, a locater probe and the second part being the combination of the first work engaging member, the second work engaging member and the pawl.

In another embodiment, the fastener of the invention is essentially in three parts, namely a first part being a longitudinal body including the ratchet teeth and including, by integration or by connection, the second work engaging member, a second part being the first work engaging member combined with the pawl element and a third part located internally of the longitudinal body and optionally including the locater probe.

The fastener in the two part embodiment can be suitable for situations where the work surfaces are not widely spaced apart and only a relatively small movement is required to draw them together. The fastener in the three part embodiment can allow more movement and depth capacity and can be suitable for drawing together work surfaces which are located more widely apart. The three part embodiment can permit a wider range of adjustment.

The fastener of the invention may be inserted in the aperture by hand. Preferably, the fastener is then tightened in position by (for example) advancing the pawl member along the ratchet teeth, by use of a suitable tool. A tool for tightening cross ties or cable ties may be adaptable for this purpose. Whereas in the case of prior art Cleco fasteners, the installer must first load the Cleco fastener in the tool, insert the fastener in the aperture and then release the spring in the fastener, in the case of the fastener of the present invention, the procedure can be carried out more efficiently. For example, a first operator may simply push the fastener into the aperture and a second operator can follow closely behind tightening the fasteners.

The fasteners of the first aspect of the invention can carry out functions in addition to that of fastening. For example, the fastener may include means for attaching one or more elements, such as cables. By way of another example, the fastener may be integrated with an element which needs to be mounted or annexed in a permanent or semi-permanent way to the work surface. Preferably, the attachment or integration takes place in conjunction with the first work engaging member, one embodiment of which is a pressure foot. It will be apparent to one skilled in the art that the attachment or integration can take place via other means on the fastener and that these are within the scope of the invention.

In more detail, one non-limiting example of such a secondary function of the fastener of the invention is the integration of a cable tie with the first working engaging member. The cable tie may be otherwise a conventional cable tie which encircles a cable or a plurality of cables and which can be drawn up around them by the use of ratchet teeth and a pawl in the normal manner. Similarly, hooks or loops can be attached to, or form part of, the fastener for mounting artwork or signage on walls or for mounting furniture, such as kitchen cupboards. It will be appreciated by one skilled in the art that there is a myriad of other uses.

It is preferred that the fastener of the invention is provided mounted in a continuous feeder strip. In the case where the fasteners are to be mounted by hand, this method of presentation can streamline the selection of fasteners and their manipulation. However, the continuous feeder strip may also be suitable for feeding automatically into a hand tool or robot.

The fasteners may be inserted into a continuous feeder strip. Alternately, the fasteners may be manufactured integrally with a continuous strip. The latter may be particularly suitable where the fasteners are formed by injection moulding: the fasteners may be connected together by a web to form a long strip of fasteners. Fasteners inserted into or manufactured in a continuous strip may be supplied as a cartridge, or in strips of appropriate length, for example, containing 20, 30 or 40 fasteners.

Where a machine tool or robot is used for the fasteners of this invention, the machine tool or robot may be driven in any suitable manner, but preferably pneumatically.

The present invention, in connection with the first aspect, also includes a method of fastening work surfaces using the fastener of the invention, the method including the steps of:
inserting the second work engaging member into an aperture in the work surfaces;
causing the means included in the second work engaging member to assume the second position of wide cross-sectional area;
causing the first work engaging member to advance on the longitudinal body to hold the work surfaces in desired contact between the first and second work engaging members; and
optionally removing substantially all of the longitudinal body accessible beyond the first work engaging member and the advance element.

In further association with the first aspect of the invention, the present invention provides a method of removing the fastener of the invention from work surfaces fastened by the fastener, the method including the steps of:
causing the second work engaging member to assume the first position of narrow cross-sectional area; and
withdrawing the fastener from the aperture in the work surfaces.

In order to cause the second work engaging member to assume the first position, in some embodiments it may be necessary to disengage the position adjusting means, such as the pawl element from the ratchet teeth, for example, in the two-part embodiment referred to above. This may involve breaking off part of the pawl element. In other cases, it may not be necessary to disturb the engagement of the pawl element with the ratchet teeth. Further details of these arrangements are illustrated in the accompanying drawings and described below.

In a second aspect, the present invention provides a fastener including:
a first longitudinal body having first engaging means; and
a second longitudinal body having:
   an opening adapted to receive the first longitudinal body; and
   second engaging means in at least part of the opening;
      wherein the first and/or second engaging means is adapted to deform sufficiently to permit the first longitudinal body to slide axially through the opening in the second longitudinal body and wherein the second engaging means is adapted to engage the first engaging means on the first longitudinal body when one longitudinal body is rotated relatively to the other.

In an especially preferred embodiment relevant to temporary fasteners or tack fasteners, the fastener of the second aspect of the present invention includes means capable of assuming a first position of narrow cross-sectional area and a second position of wide cross-sectional area. This means is preferably part of or attached to the second longitudinal body.

It is further preferred that the first and second engaging means permit unidirectional movement of the first longitudinal body within the second longitudinal body so that, once the first longitudinal body is inserted in the opening in the second longitudinal body, the first longitudinal body can be pulled in one direction within the second longitudinal body but can not be pushed in the opposite direction.

The first longitudinal body is preferably a rivet made of a relatively hard plastic. The first longitudinal body may be suitable for manufacture by injection moulding.

The first longitudinal body may include the first engaging means for some or all of its length. One end of the first longitudinal body is preferably designed to engage an insertion tool, while the other end preferably takes the form of a probe to assist in insertion into apertures in work pieces.

Each of the first and second engaging means may be chosen from a range of configurations, such as helical thread, grooves and projections, serrations, sharp-edged annular projections, burrs and other suitable gripping members. When the fastener of the invention is designed to permit unidirectional movement of the first longitudinal body within the second longitudinal body, the first and second engaging means should operate so that there is ratchet effect between the first and second engaging means. The most preferred arrangement is one where the first engaging means is a helical thread or serrations, grooves/projections, etc, each having a shoulder adapted to engage a barb or shoulder in the second engaging means, to prevent bidirectional movement of the first longitudinal body.

The second longitudinal body is preferably generally cylindrical, with the second engaging means located in one part of the cylinder. The means capable of assuming a first position of narrow cross-sectional area and a second position of wide cross-sectional area, when present, preferably comprises a continuation of the cylinder, the cylinder being segmented in this area. These means are preferably wings hinged to the remainder of the cylinder.

In one preferred embodiment, the second engaging means takes the form of threads or annular grooves and projections, adapted to deform and increase in cross-sectional area through longitudinal slits cut into the threads or grooves and projections. In a second preferred embodiment, the second engaging means is shaped in an appropriate manner, to allow the first longitudinal body to slide axially through the opening. The second engaging means, in this embodiment, takes the form of internal threads or projections in at least part of the opening, and have an annular shape in cross-section, except that the annulus is shaped so that the inner periphery of the annulus is changed to the periphery of a hexagon. Other configurations may also be appropriate.

It will be appreciated by one skilled in the art, having read the above disclosure, that the relationship between the first and second engaging means will be such that the second engaging means permits axial movement, possibly unidirectionally, of the first longitudinal body within the opening, but can effect positive engagement of the first engaging means and the second engaging means when one longitudinal body is rotated relatively to the other.

While the above preferred embodiments refer to deformation of the second engaging means, it is to be appreciated that the fastener of the present invention may be constructed so that the first engaging means deforms, or so that there is some deformation of each of the first and second engaging means.

Especially where it is the second engaging means which deforms, it is preferred that the second longitudinal body is made from a relatively stiff plastic, such as glass-filled Nylon (trade mark). Suitable material is marketed by Du Pont, under the trade mark ZYTEL.

The second aspect of the invention in its broadest form represents an extremely efficient, quick coupling fastener. When it is used as a temporary fastener or tacking rivet, it can permit rapid attachment of work pieces with the ability to pull work surfaces together with a fine degree of adjustment.

The third aspect of this invention is concerned with variations of the “Fixing and Release Systems” invention, first disclosed in international patent application No. PCT/AU99/00185 (WO99/47819). The contents of that specification are incorporated herein by reference.

In a broad form, the Fixing and Release Systems invention as applicable to the third aspect of the present invention disclosed:
a connecting means adapted to releasably fix a first element and a second element, the connecting means including a locking means movable by remote activation means between a locked position in which the first element is locked to the second element and an unlocked position in which the first element is released from the second element, characterised in that there is no permanent material connection (as defined in the specification) between the connecting means and the remote activation means.

In a preferred embodiment of WO99/47819, the locking means is moveable in a deformable channel and in the first position the locking means prevents deformation of the channel in the region of the locking means.

In the variations in the third aspect of this present invention, the fastener is particular useful as a strip fastener. In this variation, the locking element is one, but preferably more than one, rotatable element adapted to be rotatable within the deformable channel, the axis of rotation being transverse to the longitudinal axis of the channel. The rotatable locking element is designed to present a wide dimension towards the mouth of the channel when the fastener is in the locked position and a narrow dimension towards the mouth of the channel when in the unlocked position. The mouth of the channel is prevented from deforming inwardly when the locking element locks it via the wide dimension. The mouth of the channel can deflect inwardly when the locking element presents the narrow dimension towards the mouth of the channel.

Preferably, the locking element is moveable by a magnet or electromagnet from the locked to the unlocked position. Even more preferably, there is a plurality of locking elements side by side with each other and each uses magnetic means to maintain alignment with its neighbour. The purpose of this is to enable each “set” of rotatable locking element to rotate in unison, so that all present their narrow edges to the mouth of the channel at the same time or, conversely, all present their wide edges to the mouth of the channel at the same time.

In a simple version of this type of fastener, a magnet can be “swiped” along a line of locking elements to cause them to rotate through 180°, to either lock or unlock. Reversing polarity of the magnet and swiping it again will cause the locking elements to rotate through 180° to regain their original position.

The rotatable elements may take any desired shape, provided they perform the desired function of preventing inward deflection of the relevant part of the walls (eg, the mouth) of the channel when in the locked position. As one example, the rotatable locking element may resemble a wedge in side elevation and a circle or square in plan view. As another example, the locking element may itself be two or more rotatable elements with the shape of each in side elevation being constant, eg, a rectangle. In this latter example, the rotatable elements cause a bar or similar means to be raised or lowered. When the rotatable elements are caused to rotate in one direction, the bar is elevated to prevent deflection of the relevant part of the channel walls. When the rotatable elements are rotated further or in the reverse direction, the bar is caused to descend.

Other embodiments of the locking means are possible and will be apparent to one skilled in the art.

### BRIEF DESCRIPTION OF THE DRAWINGS

The invention in its various aspects will now be described in connection with certain non-limiting examples thereof described in the accompanying drawings:

FIG. 1 shows in side elevation, partly in section, a first embodiment of the fastener of the invention in the first aspect, inserted into an aperture in work surfaces;

FIG. 2 is a cross-sectional view taken along the lines 2-2 of FIG. 1;

FIG. 3 is a cross-sectional view taken along the lines 3-3 of FIG. 1;

FIG. 4 is a cross-sectional view taken along the line 4-4 of FIG. 1;

FIG. 5 shows a fastener similar to that in FIG. 1 after first insertion into an aperture in work surfaces;

FIG. 6 is part of a continuous feeder strip from which the fastener in FIG. 5 has been taken for insertion;

FIG. 7 shows the fastener of FIG. 5 during the process of drawing the work surfaces together;

FIG. 8 shows a further progression of operation of the fastener in FIGS. 5 and 7, with the work surfaces fastened and part of the fastener having been detached;

FIG. 9 shows the first part of the removal process of the embodiment in FIGS. 5, 7 and 8;

FIG. 10 shows the final part of the removal process of the fastener in FIG. 9;

FIG. 11 shows in side elevation, partly in section, a second embodiment of the fastener of the invention in the first aspect, after initial insertion into apertures in the work surfaces;

FIG. 12 shows the fastener of FIG. 11 after the fastener has been used to fasten the work surfaces together and part of the fastener has been detached;

FIGS. 13, 14, 15 and 16 show in sequence the progress of insertion of the embodiment in FIGS. 11 and 12, with FIG. 13 being essentially the same as FIG. 11 and FIG. 12 being included in FIG. 16;

FIGS. 17 and 18 show in sequence the removal of the FIG. 12 embodiment;

FIG. 19 shows in side elevation, partly in section, a variation of the FIG. 12 embodiment, integrated with a cable tie;

FIG. 20 shows the embodiment of FIG. 19 with the cable tie drawn around a cable (not shown) and locked into position;

FIG. 21 is a longitudinal cross-section of a first embodiment of the fastener of the invention in the second aspect;

FIG. 22 shows, on a small scale, the first and second longitudinal bodies of FIG. 21;

FIG. 23 is a cross-sectional view taken along the lines 3-3 of FIG. 21;

FIG. 24 illustrates in enlarged detail engagement of the first and second engaging means;

FIG. 25 is a longitudinal cross-sectional view of a second embodiment of the invention in the second aspect;

FIG. 26 is a cross-sectional view taken along the lines 6-6 of FIG. 25;

FIG. 27 shows the embodiment of FIG. 25 with the means capable of assuming first and second positions in the second position of wide cross-sectional area.

FIG. 28 shows a number of the fasteners of the invention (such as the embodiment in FIGS. 1 to 4) in position in the fuselage of an aircraft under construction;

FIG. 29 shows an embodiment of the third aspect of the invention, in side elevation;

FIG. 30 shows the FIG. 29 embodiment in end elevation;

FIG. 31 shows the FIG. 29 embodiment in top plan view;

FIG. 32 shows the FIG. 29 embodiment in perspective view;

FIG. 33 shows the FIG. 29 embodiment in exploded view (perspective, from above); and

FIG. 34 shows the FIG. 29 embodiment in exploded view (perspective, from below).

### BEST METHODS FOR CARRYING OUT THE INVENTION

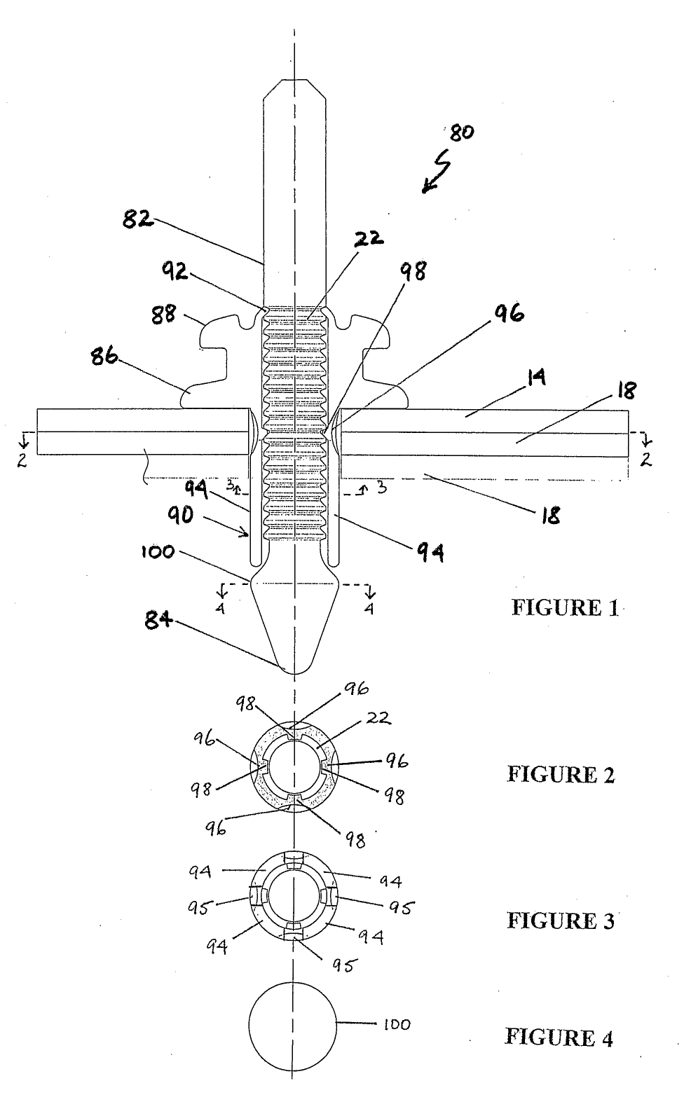

Referring first to FIGS. 1 to 4, fastener 80 is intended for manual use and is shown inserted in aperture 12 in first work piece 14 and aperture 16 in second work piece 18. Normally at this stage, second work piece 18 may be spaced from first work piece 14 as shown in dotted outline in FIG. 1. (FIGS. 5 and 7 show the normal progress in drawing work pieces 14 and 18 together). Work piece 14 may represent, for example, a panel of skin for an aircraft while work piece 18 may represent part of the frame for the aircraft.

Fastener 80 has longitudinal body 82 which carries several ratchet teeth 22. At the end of fastener 80, intended for insertion in apertures 12 and 16, is a probe 84 to help with alignment.

Fastener 80 has, moulded in one piece, first work engaging member 86 (in the form of a pressure foot), pawl element 88 and second work engaging member 90. Pawl element 88 engages ratchet teeth 22 through ratchet lock 92.

In this embodiment, second work engaging member 90 is made of four leaves 94. In FIG. 1 these are shown in the first position of narrow cross-sectional area, encircling part of longitudinal body 82. Also as shown in FIG. 1, at their base, leaves 94 are attached by a narrow strip of material 96 to foot 86. The purpose of this is described below. Narrow strip of material 96 also includes a second ratchet lock 98 for engaging teeth 22.

Probe 84, which is located at one end of longitudinal body 82, tapers out to expanded part 100. When longitudinal body 82 is moved upwardly (with reference to the orientation shown in FIG. 1), expanded part 100 forces apart leaves 94, so that second work engaging means 90 can assume the second position of wide cross-sectional area. For this to occur, work pieces 14 and 18 need to be in the position shown in hard outline in FIG. 1, otherwise leaves 98 are not able to be expanded outwardly by part 100. Work pieces 14 and 18 may be brought together by, for example, downward pressure on foot 86 and/or by drawing longitudinal body 82 upwardly.

FIG. 2, which is a cross-sectional view taken along the lines 2-2 of FIG. 1, approximately through the interface between work surfaces 14 and 18 (and omitting those work surfaces), shows the narrow strip of material 96 and the second ratchet lock 98. It will be seen that there are four second ratchet locks 98 and that these correspond to four narrow strips of material 96. In contrast, in this embodiment, ratchet lock 92 is not provided in segments, but is continuous to encircle the relevant tooth 22.

In FIG. 3, it can be seen that leaves 94 are provided with a gap 95 between neighbouring leaves. It may be desired to provide leaves 94 with a narrower gap, or no discernible gap. In FIG. 3, the location of second ratchet locks 98 and narrow strips of material 96 are shown, but these are to be regarded as in dotted outline, since they are not in fact visible in the cross-section.

Whereas the embodiment in FIGS. 1 to 4 is suitable for manual insertion, the slight variation shown in FIGS. 5 and 7 to 10 is intended to be useful for insertion by a hand tool or tool powered, for example, by air. It may be noticed that longitudinal body 82 in FIG. 1 is somewhat longer than that in FIG. 5 and FIGS. 7 to 8.

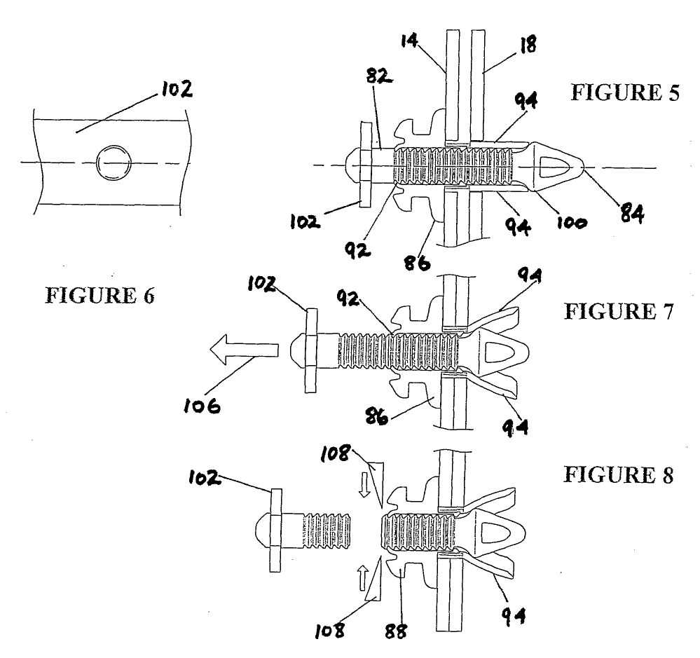

With reference to FIGS. 5 and 6, for insertion of fastener 80 into apertures 12 and 16, and in order to fasten work pieces 14 and 18, fastener 80 is fed from continuous feeder strip 102 (FIG. 6). It is to be noted that strip 102 is shown as attaching fasteners 80 near the “head” of each fastener 80. It is within the scope of the invention that the continuous feeder strip 102 is joined to some other part of fastener 80, for example, foot 86 or pawl element 88. Fastener 80 is pushed into apertures 12 and 16.

Work pieces 14 and 18 are caused to move together to the position shown in FIG. 7, for example by pressure on foot 86, by advancing pawl element 88 down ratchet teeth 22. When fastener 80 is moved in the direction of arrow 106 in FIG. 7, expanded part 100 of longitudinal body 82 causes leaves 94 to flare out as illustrated, fastening work pieces 14 and 18 together. At this stage, ratchet locks 92 and second ratchet lock 98 are engaged with teeth 22.

The part of longitudinal body 82 beyond pawl element 88 can now be sheared off by a suitable cutting means (partially shown at 108), as shown in FIG. 8. The result is a neat fastener which can hold the work pieces together while riveting or other permanent fastening takes place in nearby rivet holes (not shown). This can be particularly useful if the rivets are to be inserted by robot, since the sheared-off fastener presents a low profile and does not impede robotic operation.

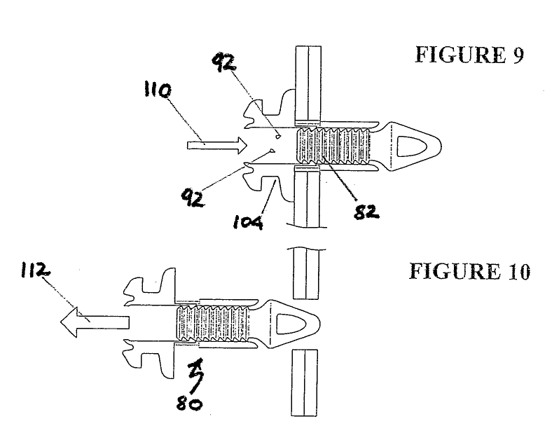

If it is desired to remove fastener 80, the procedure shown in FIGS. 9 and 10 is followed. As shown in FIG. 9, the remaining part of longitudinal body 82 is push in the direction of arrow 110. In order to do this, a tool (not shown), may be used to grip the combined pawl/foot body by using channel 104 and punch longitudinal body 82 with sufficient force to break off ratchet lock 92. Fragments of ratchet lock 92 are shown symbolically in FIG. 9, it being recalled that in fact ratchet lock 92 represents a circumscribing impingement. Second ratchet locks 98, however, remain in engagement with teeth 22 (refer FIG. 2). After longitudinal body 82 has been pushed away from pawl element 88 sufficiently for leaves 94 to return to their closed position, fastener 80 may be withdrawn from work pieces 14 and 18 as shown in FIG. 10. Because of the engagement between second ratchet lock 98 and teeth 22, pulling fastener in the direction of arrow 112 in FIG. 10 will result in withdrawal of the remaining part of fastener 80 from apertures 12 and 16.

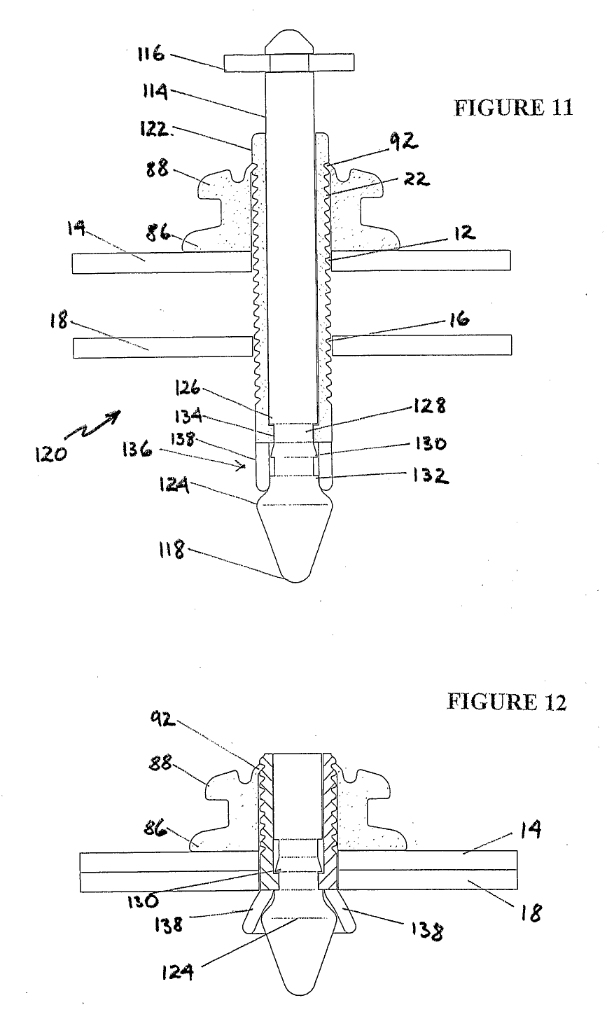

The second embodiment in FIGS. 11 to 18 will now be described. Looking first at FIG. 11, fastener 120 has longitudinal body 122 carrying several ratchet teeth 22. In this embodiment, longitudinal body 122 is a cylinder. Located within the cylinder 122 is plunger 114 which has at one end continuous strip 116, fulfilling the same function as strip 102 in the previous embodiment. At the other end of plunger 114 is probe 118. Probe 118, like probe 84, has an expanded part 124. Plunger 114 is shown in FIGS. 11 and 12 as having shoulders 126, neck 128 and ramp 130 as well as stop 132. At least in the region of ramp 130, plunger 114 is sufficiently resilient to enable ramp 130 to pass through aperture 134 into longitudinal body 122. Because of the slope between neck 128 and the widest part of ramp 132, plunger 114 can be moved from the position shown in FIG. 11 shown in FIG. 12 relatively easily. However, because of contact between the widest part of ramp 130 and shoulder 126, more force is required to reverse the movement of plunger 114.

In the FIG. 11 embodiment, first work engaging member 86 and pawl element 88 are basically the same as in the FIG. 1 embodiment and consequently the same numerals have been used. The difference between the respective embodiments in this regard is that, in the FIG. 11 embodiment, there are essentially three parts—plunger 114, longitudinal body 122 and foot 86 (combined with pawl element 88). In the FIG. 1 embodiment, there are two parts, namely longitudinal body 82 and foot 86 (combined with pawl element 88 and second work engaging means 90).

In the FIG. 11 embodiment, second work engaging means 136 is formed with leaves 138 as in the previous embodiment, but is part of, or joined to, longitudinal body 122. Expanded part 124 of probe 118 is used to open up leaves 138 to the second position of wide cross-sectional area.

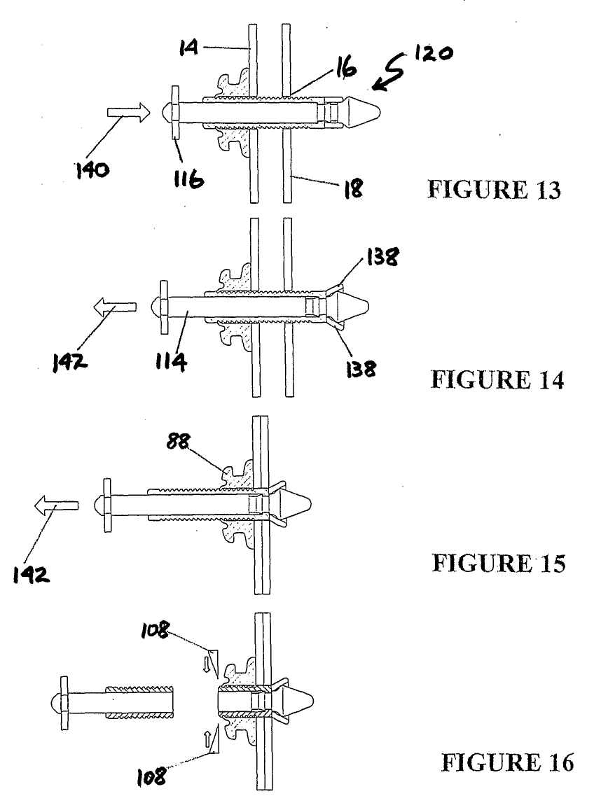

Turning to the sequence of insertion shown in FIGS. 13 to 16, in FIG. 13 work pieces 14 and 18 are shown in a wider spaced apart relationship than in FIG. 5. Fastener 120 is inserted in apertures 12 and 16 by moving fastener 120 in the direction of arrow 140. As is the case of the previous embodiment, insertion takes place by hand tool or robot, using fasteners mounted on a continuous feeder strip 116 like that shown in FIG. 6 as 102.

Next, as shown in FIG. 14, plunger 114 is moved in the direction of arrow 142 in FIG. 14. In doing so, ramp 130 is drawn through aperture 134 to the position shown in more detail in FIG. 12. At the same time, expanded part 124 of probe 118 forces leaves 138 apart.

Continued tension on fastener 120 in the direction of arrow 142, combined with advancement of pawl element 88 down ratchet teeth 22, draws work pieces 14 and 18 together as shown in FIG. 15. At this point the superfluous part of fastener 120 is snipped off by cutting means 108. As can be seen by FIG. 16, the remaining part of fastener 120 securely holds work pieces 14 and 18 together.

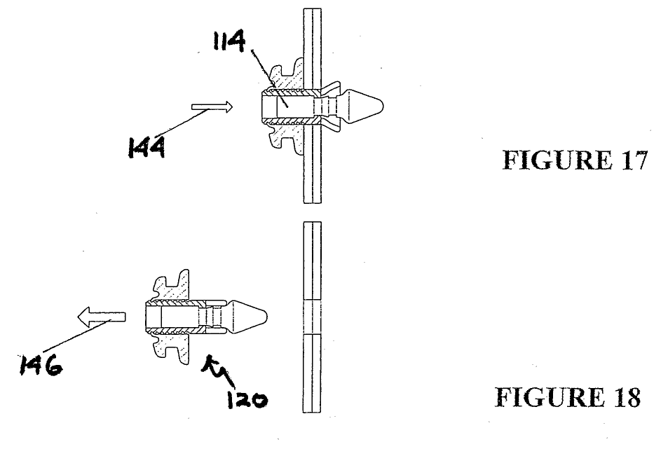

To remove fastener 120, refer to the procedure shown in FIGS. 17 and 18. A tool (not shown) is used to punch the remaining part of plunger 114 in the direction shown by arrow 144 with sufficient force to fracture ramp 30 against the narrow portion of aperture 134. Then expanded part 124 of probe 118 can be moved away from leaves 138, which accordingly can collapse. Ratchet lock 92 in teeth 22 enables fastener 120 to be withdrawn in a single piece as shown by arrow 146 in FIG. 18.

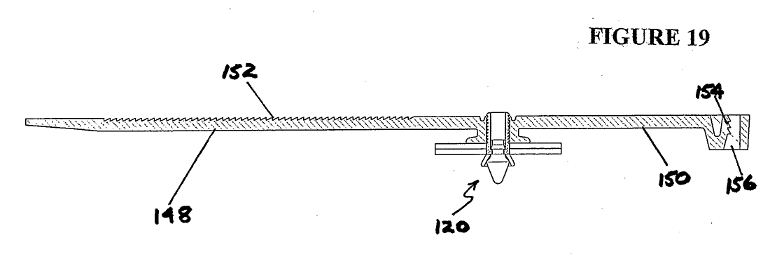

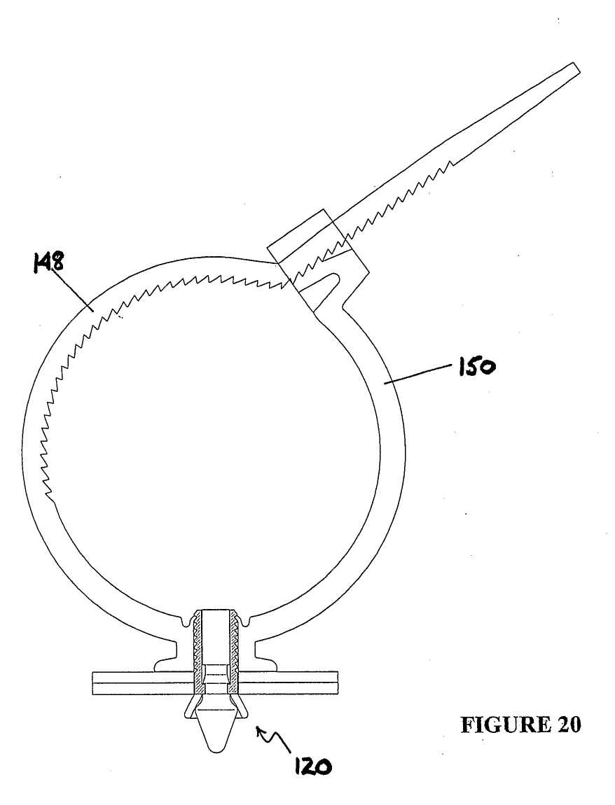

Turning now to FIG. 19, there is shown integrated with the FIG. 12 embodiment (after removal of the superfluous part (refer FIG. 16)) a cable tie having resilient arms 148 and 150. The cable tie is shown as integrated with pawl element 88 combined with foot 86. It will be appreciated that the cable tie could instead be integrated with the same elements in the FIG. 1 embodiment.

As is the case with conventional cable ties, arm 148 carries teeth 152 and arm 150 includes complementary teeth 154 in passage 156.

Once fastener 120 has been inserted in the manner illustrated in FIGS. 13 to 16, a cable (not shown) is placed in position and arm 148 is inserted through passage 156 and drawn up sufficiently to snugly encircle the cable, teeth 152 meshing with teeth 154 in the usual manner.

It will be appreciated that, instead of the cable tie, another type of fastening element could be used, such as a loop (for hanging pictures for example) or a cup hook. Alternately, fastener 120 could be integrated with any other type of product which it was desired to annex or affix to a work piece.

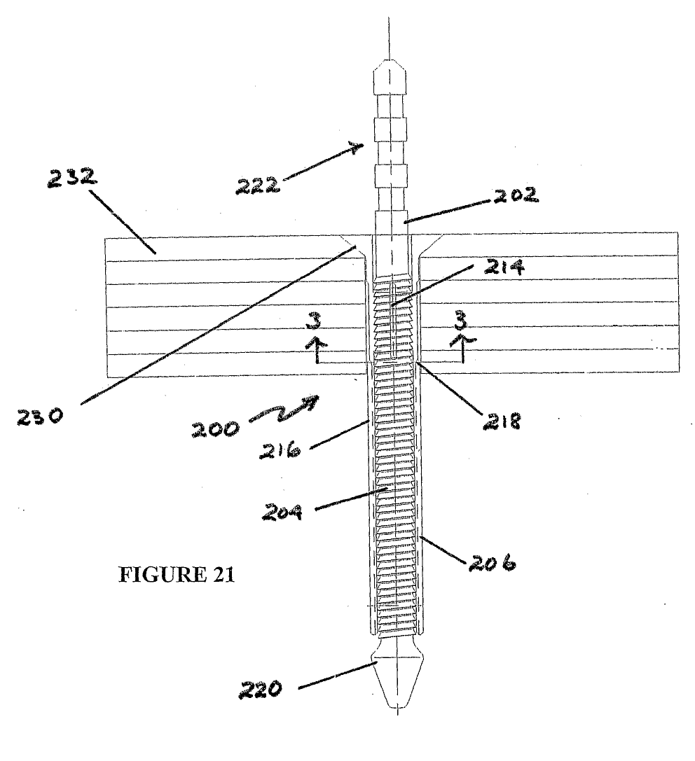

Reference is now made to FIGS. 21 to 27 (the second aspect of the invention).

It will be appreciated that the embodiments in these drawings are illustrative of embodiments of a temporary fastener or tacking rivet. However, these drawings also serve to illustrate how the invention would work in other situations, if the means capable of assuming the first and second cross-sectional area, positions is omitted.

Referring first to FIGS. 21-24, fastener 200 has first longitudinal body 202 having first engaging means 204. In this embodiment, first engaging means 204 is a helical screw thread of 0.6 mm pitch.

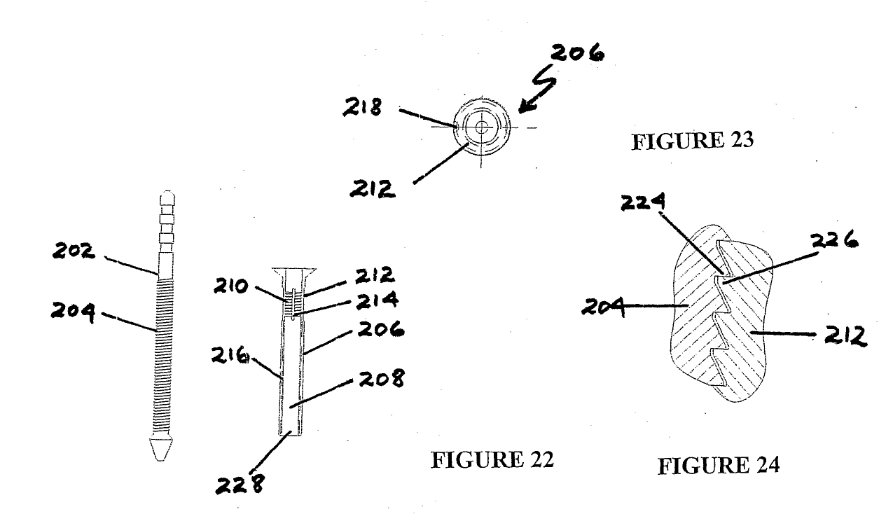

Second longitudinal body 206 has general cylindrical opening 208. Opening 208 continues through throat 210. Throat 210 has second engaging means, in this embodiment being internal helical threads 212. In the region of throat 210, second longitudinal body 206 has slits 214. Only one slit 214 is shown in FIGS. 21 and 22. Preferably, there are four such slits 214.

Second longitudinal body 206 includes wings 216. These are attached to longitudinal body 206 at hinges 218 and are preferably provided as four wings, two of which are shown in FIGS. 21 and 22.

First longitudinal body 202 includes probe 220 and stepped section 222, designed to fit into an insertion tool (not shown).

First engaging means 204 and second engaging means 212 each includes shoulders 224 and 226 respectively (refer FIG. 24). The engagement between these shoulders prevents first longitudinal body 202 from moving within opening 208 in a downward direction as shown in FIG. 21. However, first longitudinal body 202 is able to move upwardly within opening 208.

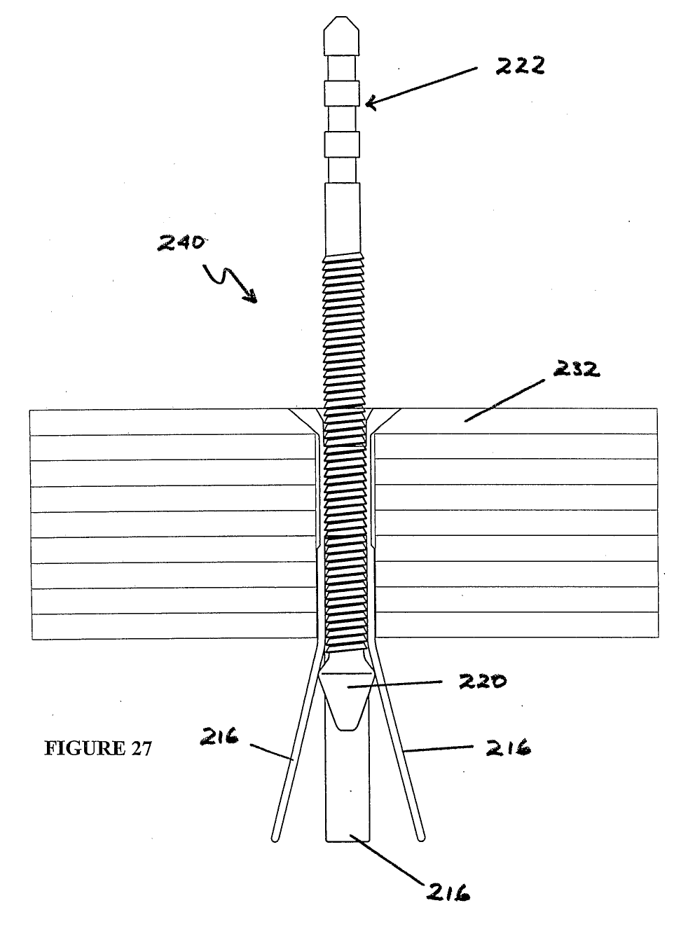

To operate fastener 200, first longitudinal body 202 is inserted into second longitudinal body 206, by feeding stepped portion 222 through opening 208 from end 228. The assembled fastener is then inserted into an insertion tool (not shown) which grips some or all of stepped portion 222. Assembled fastener 200 is inserted by the tool into countersunk hole 230 in two or more work pieces, schematically shown at 232. The insertion tool is activated so that it pulls up first longitudinal body 202 to a preset tension, shoulders 224 ratcheting along shoulders 226. Movement of probe 220 upwardly with reference to FIG. 21 causes wings 216 to flare out (in the same manner as shown in FIG. 27) to hold works pieces 232 together. The insertion tool rotates first longitudinal body 202 anti-clockwise to lock it in position in opening 208.

The protruding part of first longitudinal body 202 is trimmed off (by the insertion tool) flush with the head of counter sunk hole 230. The remaining part of first longitudinal body 202 maintains work pieces 232 together with the desired tension.

If fastener 200 is to be replaced by a permanent rivet, fastener 200 is drilled out and replaced in known manner.

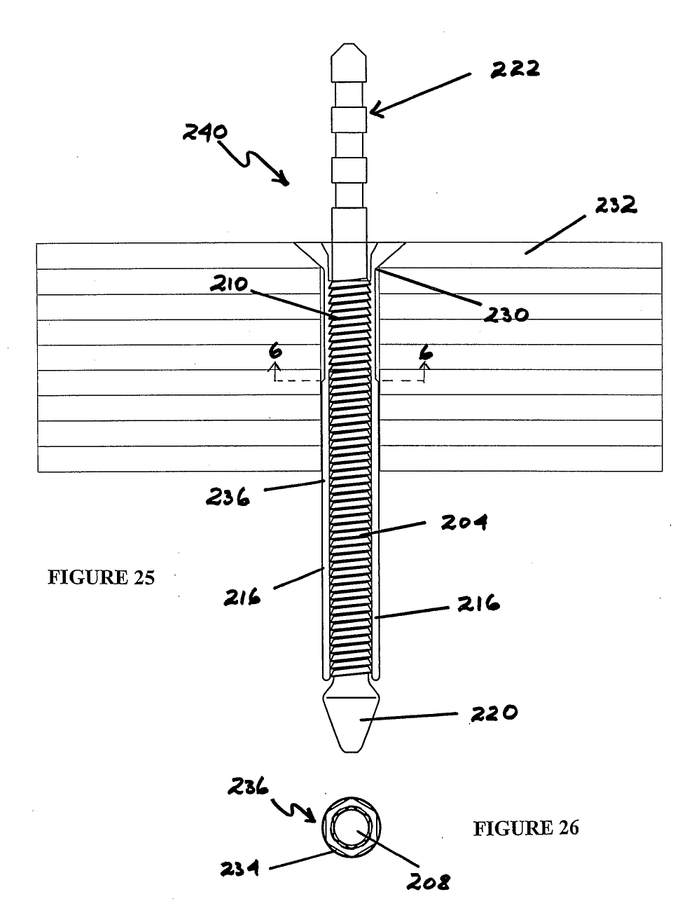

Turning now to FIGS. 25 to 27, fastener 240 is the same as fastener 200 in the previous embodiment, except for the second engaging means. Whereas, in the previous embodiment in FIGS. 21 to 23, slits 214 permitted sufficient deformation of threads 212 to allow unidirectional passage of first longitudinal body 202 within opening 208, in fastener 240 there are no slits 214. Instead, as can be seen from FIG. 26, formed internally of second longitudinal body 236 are internal threads 234 which have been formed so that their internal periphery represents the periphery of a hexagon.

Threads 234 can flex sufficiently to permit external threads 204 on first longitudinal body 202 to pass through when first longitudinal body 202 is being drawn upwardly in FIG. 25. Threads 204 and threads 234 include shoulders as illustrated in FIG. 24 for threads 204 and 212, for unidirectional movement.

The embodiment in FIGS. 25 to 27 operates the same as that described for FIGS. 21 to 24 in that first longitudinal body 202 is pulled up and twisted to lock it in place.

It is possible that the embodiment of the fastener illustrated in FIGS. 25 to 27 can provide more strength compared to that in the FIG. 21 to 24 embodiment. The internal threads 234 in the FIG. 25 to 27 embodiment can deform horizontally without the requirement for slits 214 as in the FIG. 21 to 24 embodiment.

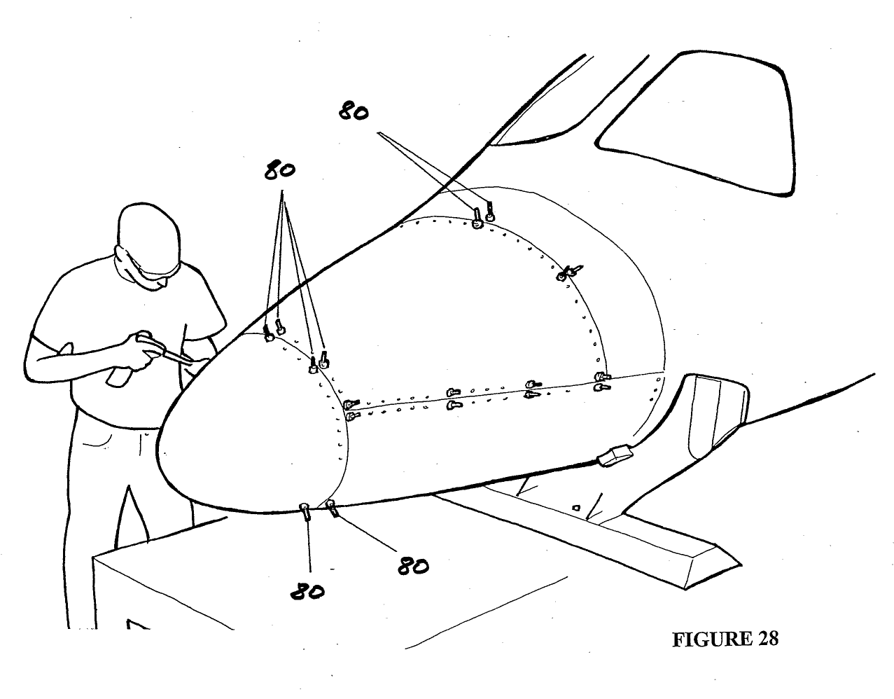

FIG. 28 shows part of an aircraft fuselage being riveted, with several fasteners 80 in place. All the fasteners shown are those of the present invention, although only some are labelled. So that the apertures occupied by fasteners 80 can also be riveted, fasteners 80 need to be removed, as explained above.

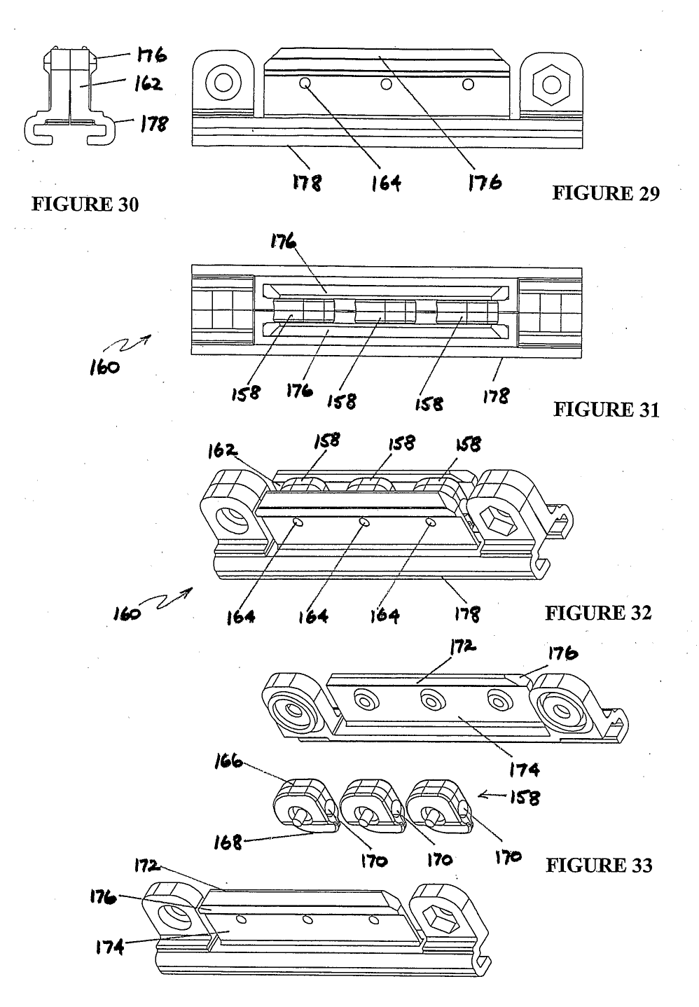

Turning now to the embodiment of the third aspect of the invention in FIGS. 29 to 34, fastener 160 is shown in the form of a strip fastener. It is to be understood, however, that the fastener could take the form of a discrete fastener.

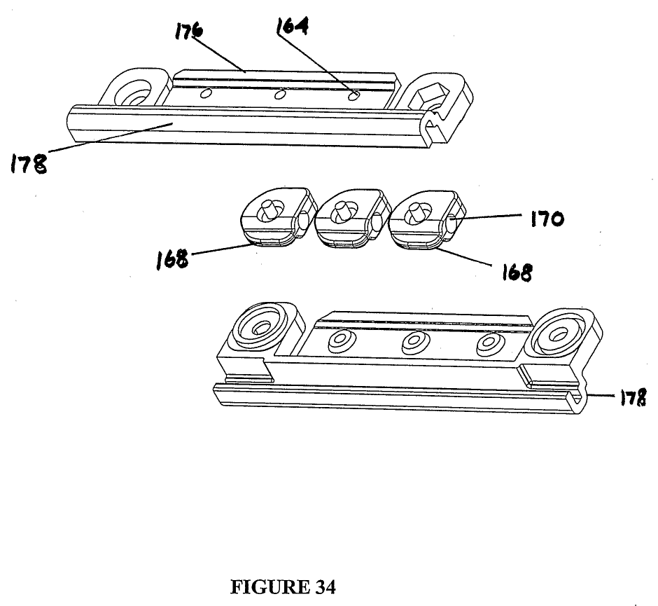

Fastener 160 has three rotatable locking elements 158 mounted in channel 162. Each locking element 158 can rotate about axis 164. Each locking element 158 is generally wedged-shaped in side elevation, having a thick edge 166 opposite a thin edge 168 (refer FIG. 34). Each locking element 158 includes a magnet 170.

As best seen in FIG. 32, when fastener 160 is locked, thick edges 166 of locking elements 158 lie between the upper parts 172 of arms 174 of channel 162. In this configuration, an element (not shown) which is engaged by protrusion 176 is prevented from moving out of engagement from protrusion 176, since upper part 172 of arm 174 is prevented from deflecting inwardly, because of the presence of the thick edges 166 of locking elements 158.

In order to release the engagement by protrusion 176 with the element (not shown), it is necessary to rotate locking elements 158 so that the thin edges 168 are situated at the upper part 172 of channel 162. To achieve this, a simple bar magnet may be swiped along base 178 or in its region. Depending on polarity of the magnet, locking elements 158 will rotate through 1800 either to the right or to the left. A magnet 170 on each locking element 158 ensures that all locking elements rotate in unison. When thin edges 168 lie between upper parts 172, there is room for deflection and protrusion 176 may no longer engage the element (not shown).

Reversing the polarity of the bar magnet and swiping it again will cause the locking elements 158 to turn to their original position.

As will be appreciated by one skilled in the art, rotation of locking elements 158 may be achieved by other means, for example by use of a electromagnetic field. In another embodiment (not shown), locking elements 158 may have consistent thickness throughout, rather than being wedge type and shaped as shown in FIGS. 33 and 34. Instead, a locking bar may be attached to the rotatable locking element. Rotation of the elements can be used to raise the locking bar between upper parts 172 of arms 174, preventing inward deflection. Further rotation of the locking elements can return the locking bar to the original unlocked position.

As explained in further detail in patent application No. WO99/47819, the locking and unlocking may be effected by remote activation, with no material connection made between the actuating means, such as the magnet, and the locking elements. It is within the scope of the present invention, however, that hard wiring, or other material connection, may also be used in the case of the third aspect of the invention.

### INDUSTRIAL APPLICABILITY

It is anticipated that the fasteners of the present invention can be manufactured at a very low price and that, because the first work engaging member (in the fastener of the first aspect) can be made of plastic or other mouldable material, it will be economical to provide the fastener with variations in that member—for example, to accommodate use with curved surfaces.

Further, it is easy to adapt the fasteners of the present invention to composite work pieces and to minimise damage during temporary assembly.

In relation to industries where it is desirable to use temporary fasteners until permanent fasteners are inserted, and especially where robots insert the permanent fasteners, the versions of the fastener of the invention where part of longitudinal body can be sheared off are particularly useful. The sheared off fastener presents a low-profile appearance which does not impede robotic operation.

The connecting means of the invention is useful as a simple lock which can be hidden from view and which can be operated by a bar magnet or other activator. One application is as a lock for a medicine cabinet, for example.

It will be further appreciated by one skilled in the art that the scope of the present invention is not limited to the particular embodiments described and that modifications and variations are within the scope of the invention.

1. A fastener including:
a longitudinal body;
a first work engaging member mounted on the longitudinal body and adapted for movement relative thereto towards a work to be engaged;
a second work engaging member associated with the longitudinal body; and
means on the longitudinal body for adjusting position of the first work engaging member on the longitudinal body,
the second work engaging member including means capable of assuming a first position of narrow cross-sectional area and a second position of wide cross-sectional area.

2. The fastener of claim 1, wherein the first work engaging member is a pressure foot mounted on the longitudinal body and adapted to be urged towards work surfaces which are to be trapped between the first work engaging member and the second work engaging member.

3. The fastener of claim 1, wherein the second work engaging member is mounted on or attached to or integral with the longitudinal body.

4. The fastener of claim 1, wherein the second work engaging member is integral with, or joined to, the first work engaging member.

5. The fastener of claim 1, wherein the means capable of assuming the first and second positions includes wings or leaves.

6. The fastener of claim 1, wherein the position adjusting means includes ratchet teeth and a pawl.

7. The fastener of claim 6, wherein the ratchet teeth are on the longitudinal body.

8. The fastener of claim 6, wherein the pawl is formed integrally with the first work engaging means.

9. The fastener of claim 8, wherein the first work engaging member, the second work engaging member and the pawl element are made in one piece or are in a fixed spatial relationship.

10. The fastener of claim 1, wherein the second work engaging member is connected to or integral with the longitudinal body.

11. The fastener of claim 1, which includes means for attaching one or more elements.

12. The fastener of claim 11, wherein a cable tie is integrated with the first work engaging member.

13. The fastener of claim 1 when mounted in or formed with a feeder strip.

14. A method of fastening work surfaces using the fastener of claim 1, the method including the steps of:
inserting the second work engaging member into an aperture in the work surfaces;
causing the means included in the second work engaging member to assume the second position of wide cross-sectional area;
using the position adjusting means to cause the first work engaging member to move on the longitudinal body towards the work surfaces so that the work surfaces are held in desired contact between the first and second work engaging members; and
optionally removing substantially all of the longitudinal body accessible beyond the first work engaging member and the position changing means.

15. A method of removing the fastener of claim 1 from work surfaces fastened by the fastener, the method including the steps of:
causing the second work engaging member to assume the first position of narrow cross-sectional area; and
withdrawing the fastener from the aperture in the work surfaces.

16. A fastener including:
a first longitudinal body having first engaging means; and
a second longitudinal body having:
an opening adapted to receive the first longitudinal body; and
second engaging means in at least part of the opening;
wherein the first and/or second engaging means is adapted to deform sufficiently to permit the first longitudinal body to slide axially through the opening in the second longitudinal body and wherein the second engaging means is adapted to engage the first engaging means on the first longitudinal body when one longitudinal body is rotated relatively to the other.

17. The fastener of claim 16 which includes means capable of assuming a first position of narrow cross-sectional area and a second position of wide cross-sectional area.

18. The fastener of claim 17, in which the means capable of assuming the first and second position is part of or attached to the second longitudinal body.

19. The fastener of claim 16, in which the first and second engaging means permit unidirectional movement of the first longitudinal body within the second longitudinal body.

20. The fastener of claim 16, wherein the first longitudinal body includes the first engaging means for some or all of its length.

21. The fastener of claim 16, wherein the first engaging means is a helical thread or serrations or grooves, each having a shoulder adapted to engage a barb or shoulder in the second engaging means.

22. The fastener of claim 17 wherein the second longitudinal body is substantially cylindrical and the means capable of assuming the first position of narrow cross-sectional area and the second position of wide cross-sectional area comprises a continuation of the cylinder, the cylinder being partially segmented.

23. The fastener of claim 22, wherein the means are wings hinged to the cylinder.

24. The fastener of claim 16, wherein the second engaging means takes the form of threads or annular grooves and projections, adapted to deform and increase in cross-sectional area through longitudinal slits cut into the threads or grooves and projections.

25. The fastener of claim 1, wherein one end of the longitudinal body is adapted to engage an insertion tool and the other end is a probe.

26. A connecting means adapted to releasably fix a first element and a second element, the connecting means including a locking means movable by activation means between a locked position in which the first element is locked to the second element and an unlocked position in which the first element is released from the second element, wherein the locking means is moveable in a deformable channel having a longitudinal axis and in the first position the locking means prevents deformation of the channel in the region of the locking means and wherein the locking means is at least one rotatable element adapted to be rotatable within the deformable channel about an axis transverse to the longitudinal axis of the deformable channel.

27. The connecting means of claim 26, wherein the locking means is wedge shaped.

28. The connecting means of claim 26 wherein the activation means includes or comprises a magnet or electromagnet.

29. The connecting means of claim 28, wherein the locking means includes two or more rotatable elements adapted to cause a bar to rise or lower

30. The connecting means of claim 26, which has two or more of the locking means.

31. (canceled)

32. (canceled)

33. (canceled)
